(19) United States
(12) Patent Application Publication
(10) Pub. No.: US 2019/0036885 A1
(43) Pub. Date: Jan. 31, 2019

(54) SYSTEM AND METHOD FOR FACILITATING THE DELIVERY OF SECURE HYPERLINKED CONTENT VIA MOBILE MESSAGING

(71) Applicant: Message 4U Pty Limited, Melbourne (AU)

(72) Inventors: Sagit SHIRAN, Melbourne (AU); Paul COLBY, Melbourne (AU)

(73) Assignee: Message 4U Pty Limited, Melbourne (AU)

(21) Appl. No.: 16/045,945

(22) Filed: Jul. 26, 2018

(30) Foreign Application Priority Data
Jul. 26, 2017 (AU) 2017902935

(51) Int. Cl. H04L 29/06

(52) U.S. Cl. CPC H04L 63/0281; H04W 4/16; H04L 63/08; H04L 63/0428

(57) ABSTRACT

A method for sending content to a mobile device comprises receiving, by a proxy service, a request containing a first URL to a web resource containing the content. In response, the proxy service: sends a first message to the mobile device containing a second URL to a web resource operated by the proxy service; communicates a unique access token to the mobile device responsive to the mobile device accessing the second URL; sends a second message to the mobile device containing a proxied URL selectable for routing the mobile device to the web resource containing the secure content, via the proxy service; receiving a request containing the unique access token from the mobile device for accessing the proxied URL; evaluating the access token in the request to determine if it corresponds to the unique access token; and, if so, proxying the content request to the web resource containing the content.

### CROSS-REFERENCE TO RELATED APPLICATIONS

This application claims the benefit of Australian Application No. 2017902935, filed Jul. 26, 2017 and entitled “A SYSTEM AND METHOD FOR FACILITATING THE DELIVERY OF SECURE HYPERLINKED CONTENT VIA MOBILE MESSAGING,” the entirety of which is hereby incorporated by reference for all purposes.

### BACKGROUND

Smartphones are being increasingly used in place of traditional computing devices to receive and view electronic content. One technique for delivering electronic content to a smartphone user is via SMS (short message service). More particularly, a hyperlink to the electronic content (e.g. stored on a remote server) can be included in the SMS. The hyperlink can be readily selected by the smartphone user for accessing and subsequently presenting the content via a suitable application resident on the smartphone.

However, by default, SMS messages are not encrypted and thus are only protected by the mobile communication network itself (e.g. a GSM network). Such mobile networks may optionally employ a weak and broken stream cypher that can be exploited by attackers seeking to intercept SMS messages being communicated over the network. It would be advantageous if there were provided a means for making content delivery via SMS more secure, without significantly impacting the end recipient's experience.

### SUMMARY

The present invention relates generally to a system and method for facilitating delivery of secure hyperlinked content via a mobile messaging protocol, such as short message service (SMS).

In accordance with a first aspect there is provided a method for sending secure content to a content recipient via a mobile device, the method comprising: (i) receiving a content delivery request message containing a first URL to a web resource containing the secure content, the content delivery request message being received by a third-party proxy service; (ii) responsive to receiving the content delivery request message, the third-party proxy service: (a) sends a first message to the mobile device containing a second URL to a web resource operated by the third-party proxy service; (b) communicates a unique access token to the mobile device responsive to the mobile device accessing the second URL; (c) sends a second message to the mobile device containing a proxied URL selectable for routing the mobile device to the web resource containing the secure content via the third-party proxy service; (d) receives a content request from the mobile device for accessing the proxied URL, the content request containing an access token; (e) evaluating the access token contained in the content request to determine if it corresponds to the unique access token previously communicated to the mobile device; and (f) responsive to making a positive determination, proxying the content request to the web resource containing the secure content.

In an embodiment the method further comprises delaying sending the second message to the mobile device after communicating the unique access token thereto.

In an embodiment the unique access token is communicated to the mobile device in a cookie, which is subsequently stored in a HTTP cookie store by a browser resident on the mobile device.

In an embodiment the cookie is included in the content request for accessing the proxied URL and wherein the third-party proxy service extracts the access token from the cookie to determine its validity.

In an embodiment the third-party proxy service processes the content delivery message to determine a unique identifier for the mobile device, such as a mobile phone number, and wherein the access token is registered against the unique identifier.

In an embodiment, step (f) further comprises determining whether a unique identifier associated with the content request message corresponds to the unique identifier associated with the content delivery message and proxying the content request in response to making a positive determination.

In an embodiment the content request is proxied to the web resource containing the secure content using a predefined encryption technique.

In an embodiment the content delivery request message is intercepted/received by an API operated by the third-party proxy service.

In an embodiment, prior to sending the first message to the mobile device, the third-party proxy service evaluates a mobile phone number or other unique identifier for the content recipient to determine if an access token has previously been assigned to the corresponding mobile device and responsive to making a positive determination, omits steps (a) and (b), and proceeds directly to step (c).

In an embodiment the messages sent by the third-party proxy service are SMS messages.

In an embodiment the second message contains a hyperlink to the proxied URL, which is selectable by the content recipient.

In accordance with a second aspect of the present invention there is provided a system for sending secure content to a content recipient via a mobile device, the system comprising a third-party proxy service configured to receive a content delivery request message containing a first URL to a web resource containing the secure content, responsive to receiving the message, the third-party proxy service further configured to: (a) send a first message to the mobile device containing a second URL to a web resource operated by the third-party proxy service; (b) communicate a unique access token to the mobile device responsive to the mobile device accessing the second URL; (c) send a second message to the mobile device containing a proxied URL selectable for routing the mobile device to the secure content web resource via the third-party proxy service; (d) receive a content request from the mobile device for accessing the proxied URL, the request containing an access token; (e) evaluate the access token contained in the content request to determine if it corresponds to the unique access token previously communicated to the mobile device; and (f) responsive to making a positive determination, proxy the content request to the web resource containing the secure content.

### BRIEF DESCRIPTION OF THE DRAWINGS

Embodiments of the present invention will now be described, by way of example only, with reference to the accompanying drawings, in which:

FIG. 1 is a schematic of a system, in accordance with some embodiments;
and

FIG. 2 is a flow chart setting out steps taken in a two-pass secure SMS method, in accordance with some embodiments.

### DETAILED DESCRIPTION

Embodiments of the invention described herein relate to a system and method for securely delivering electronic content to a mobile device user via mobile messaging. As will be outlined in detail in subsequent paragraphs, a two-pass secure delivery methodology utilising token-based authentication is employed which advantageously ensures that any unauthorised attempt to intercept the digital content can be immediately detected and reported.

FIG. 1 depicts an example system architecture in which embodiments of the present invention can be implemented. As illustrated, the system 1 includes a secure proxy service 2 (hereafter “secure service”), a message sender 4 and a message recipient 6 operating a mobile device 6a. The message sender 4 (hereafter “sender”) maintains a webserver 8 storing content to be securely accessed by the message recipient 6 (“recipient”). The sender 4 subscribes to a secure SMS service implemented by the secure service 2 that facilitates the secure delivery of the content stored on the webserver 8 to the recipient 6, by way of a SMS message. In other words, the secure service 2 operates as an intermediary third-party for ensuring digital content is delivered securely to the recipient 6. By way of example, the sender 4 may be a medical practice that wishes to send confidential test results to a patient (i.e. the message recipient 6). As shown in FIG. 1, the secure service 2 implements an API gateway 10, an access token store 12 (e.g. implemented as a database) and a webserver 14, the functions of which will be described in detail in subsequent paragraphs.

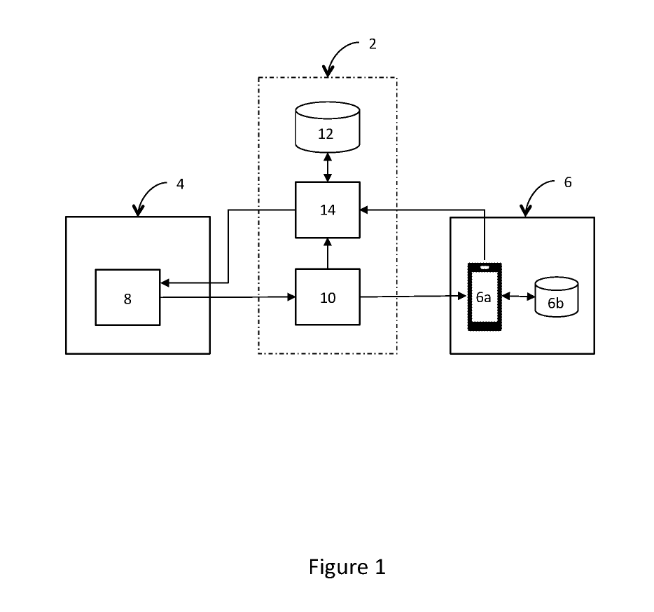

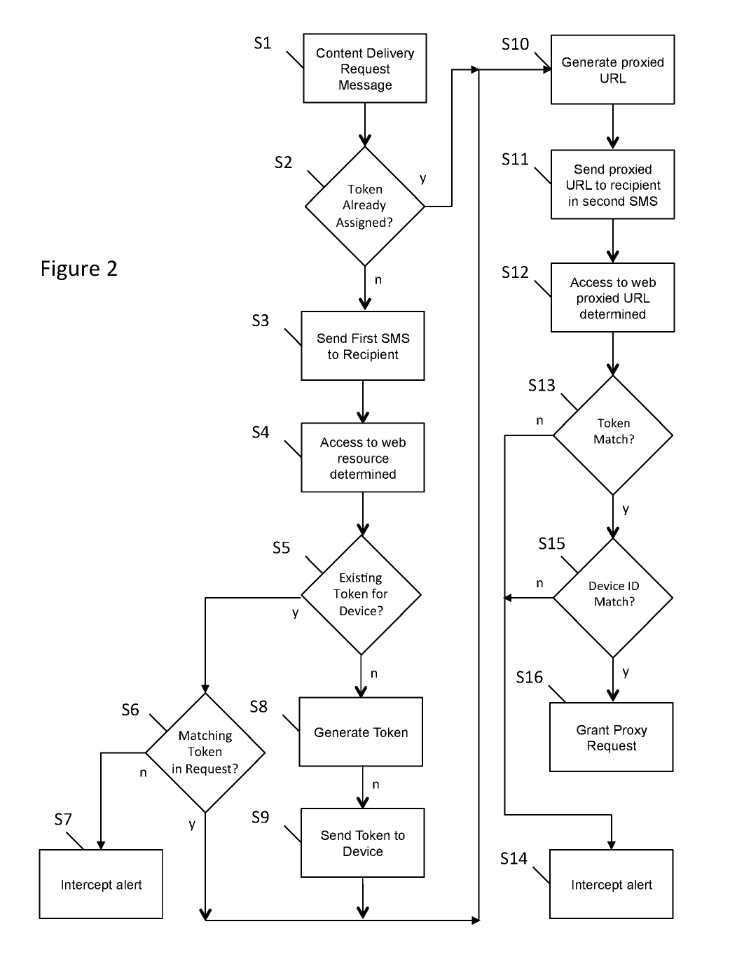

In more detail, and with additional reference to the flow chart of FIG. 2, an embodiment of the secure two-pass delivery method involves the secure service 2 receiving a content delivery request message from the sender 4 (step S1). The content delivery request message is received via the API gateway 10. The request includes a URL for a web resource providing the secure content, as well as a unique identifier for either the recipient 6 and/or their device 6a. According to the illustrated embodiment, the web resource comprises a page or other suitable file/resource which is hosted by the web server 8. The content delivery request message takes the form of a JSON (JavaScript Object Notation) document that is posted to a REST endpoint for the API gateway 10. Further, the unique identifier in this instance takes the form of the MSIDN which persons skilled in the art will understand is a number uniquely identifying a subscription in a GSM or a UMTS mobile network which maps the telephone number to the device's SIM card. Alternatively, the unique identifier could be some other identifier (e.g. device UID) that can be used by the secure service 2 to look up the recipient's mobile phone number in a data store maintained by the secure service 2.

### First Pass

At step S2, the secure service 2 determines whether the recipient 6 has previously been assigned an access token. This involves evaluating whether there is an access token in the token store 12 that is associated with the unique identifier. If there is, the method proceeds directly to the second pass, as described in subsequent paragraphs. If not, at step S3, the secure server 2 generates and sends a first SMS message to the recipient 6. The SMS message includes a URL to a token registration page stored on the web server 14. The SMS may include contextual information for the message recipient 6, such as “You have a secure SMS waiting, please visit: https://securetx.io/eidj78”. In response to the recipient 6 accessing the web resource (step S4), the secure service 2 again checks the token store 12 to confirm that there is no access token currently associated with the unique identifier (step S5). If there is an access token found, the process proceeds to step S6 where the service checks whether the corresponding token was found in the URL access request. If the URL request does include the token in the request header, the process proceeds directly to the second pass (see below). If the URL request does not include the token, the existing token associated with the unique identifier is invalidated, and the sender 4 is notified of an intercept attempt (step S7).

Returning to step S5, if there is no access token determined to be associated with the unique identifier, the process proceeds to step S8 which involves the secure service 2 generating a unique access token using techniques well understood in the art. The token is subsequently stored in the token store 12 in association with the unique identifier. At step S9, the token is communicated to the recipient device 6a. For example, the web server 14 may respond to the device 6a with a “thank you, you're setup” webpage, that includes a set-cookie header to install the token on the device 6a. In this scenario, the access token is contained in a HTTP cookie that is stored in a HTTP cookie store by a browser resident on the recipient device 6a.

### Second Pass

Once an access token has been assigned and communicated to the device 6a, it is ready to receive secure messages from the sender 4. This is referred to as the “second pass.” A first step of the second pass (step S10) involves the secure service 2 generating a proxied URL for the secured content (i.e. a URL which directs a requesting browser first to the secure service 2, before being proxied to the secure content). The proxied URL may or may not be a re-written (and possibly shortened) version of the original URL. A hyperlink for the proxied URL is communicated to the recipient 6 in a second SMS at step S11.

It will be understood that the second pass may be initiated immediately following the first pass, or at some later time (which may or may not be predefined by the service). If the two passes are within close succession, it is possible for an eavesdropper to intercept, and act upon, both the first and second SMS messages before the intended recipient 6 has responded to the first SMS message. Thus, the eavesdropper could get access to the secured content within this short time period. Once the intended recipient 6 has responded to either message, the token is invalidated and customer and/or recipient notified, so in that case the interception is detectable, and the eavesdropper's access is not sustained. The probability of this risk occurring is inversely proportional to the period between the two messages, and thus a longer period allows more time for the intended recipient to respond to the first message, and invalidate the intercepted token, before the second message is sent. It will be understood that the delay could be varied by the secure service 2 (e.g. between 5 seconds to 2 minutes) depending on the desired implementation and specifications prescribed by the sender 4.

At step S12, the recipient 6 attempts to access the proxied URL contained in the second SMS. More particularly, responsive to the recipient 6 selecting the hyperlink, the resident browser sends a request to the proxied URL which includes the cookie stored in the HTTP cookie store 6b. At step S13, the secure service 2 subsequently extracts the access token from the cookie and carries out a look-up of the token store 12 to see if there is a match (and thereby establish that the device 6a is authorised to access the secure content). If no match is found, the secure service 2 registers the request as a fraudulent attempt to access the secure content and may issue an alert to the sender 4 and/or recipient 6 (step S14). If there is a match, the secure service 2 can verify that the (now authenticated) recipient unique identifier matches the recipient identifier of the original delivery request message associated with the shortened URL (step S15). If verified, at step S16, the service 2 allows the browser of requesting device 6a to be proxied to the URL of the secure content. In an embodiment, strong encryption (e.g. TLS encryption) may be used for communications between the secure service 2 and the webserver 8.

### Alternative Embodiments and Further Technical Description

In an alternative embodiment to that described above, a recipient 6 may register with the secure service 2 prior to being sent a message from the sender 4. Using the previous medical practice scenario, a patient may opt-in to receiving “secure SMS delivery” of results, when giving their contact details to a medical practice receptionist. In another embodiment, an online web portal could be provided by the secure service for recipient registrations. Thus, the first pass of the method may be triggered by either a registration request, or automatically triggered by a secure SMS delivery being attempted for a recipient that has not yet been assigned a token.

Although preceding embodiments described the secure service 2 as an intermediary, it will be understood that the secure service 2 could be implemented directly by the message sender 4 (i.e. as opposed to being implemented as a third-party service).

It will be understood that where the secure service 2 could act as an intermediary for any number of subscribing message senders and message recipients. Each message recipient 6 implements a mobile device 6a for receiving SMS messages from the secure service 2. As described herein, the mobile device 6a takes the form of a smartphone. It will be understood, however, that any network enabled mobile device (e.g. tablet computer, laptop with mobile broadband, etc.) could be utilised.

In an alternative embodiment to that described above, the secure service 2 may store/maintain the secure content on behalf of the sender 4. For example, the secure content may be stored on the webserver 14.

The hyperlink included in the second pass message communication may take on different forms. For example, the hyperlink may be a text based link. In other embodiments, the hyperlink may be an image or video. The hyperlink may also be accessed in numerous ways depending on the device used to access said unique hyperlink. For instance, the hyperlink may be selected using a finger on a touch screen, a keypad entry, using a stylus etc.

In an embodiment, a non-replyable alphanumeric source address could be utilised at least for the first pass SMS message sent by the secure server 2.

In this specification, the word “comprising” is to be understood in its “open” sense, that is, in the sense of “including”, and thus not limited to its “closed” sense, that is the sense of “consisting only of”. A corresponding meaning is to be attributed to the corresponding words “comprise,” “comprised,” and “comprises” where they appear.

Any discussion of documents, acts, materials, devices, articles or the like which has been included in this specification is solely for the purpose of providing a context for the present invention. It is not to be taken as an admission that any or all of these matters form part of the prior art base or were common general knowledge in the field relevant to the present invention as it existed in Australia or elsewhere before the priority date of this application.

The preceding description is provided in relation to several embodiments, which may share common characteristics and features. It is to be understood that one or more features of any one embodiment may be combinable with one or more features of the other embodiments. In addition, any single feature or combination of features in any of the embodiments may constitute additional embodiments.

In addition, the foregoing describes only some embodiments, and alterations, modifications, additions and/or changes can be made thereto without departing from the scope and spirit of the disclosed embodiments, the embodiments being illustrative and not restrictive.

Furthermore, whilst the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of this disclosure. Also, the various embodiments described above may be implemented in conjunction with other embodiments, e.g., aspects of one embodiment may be combined with aspects of another embodiment to realize yet other embodiments. Further, each independent feature or component of any given assembly may constitute an additional embodiment.

We claim:

1. A method for sending secure content to a content recipient via a mobile device, the method comprising:
receiving a content delivery request message containing a first URL to a web resource containing the secure content, the content delivery request message being received by a third-party proxy service;
responsive to receiving the content delivery request message, the third-party proxy service:
(a) sending a first message to the mobile device containing a second URL to a web resource operated by the third-party proxy service;
(b) communicating a unique access token to the mobile device responsive to the mobile device accessing the second URL;
(c) sending a second message to the mobile device containing a proxied URL selectable for routing the mobile device to the web resource containing the secure content via the third-party proxy service;
(d) receiving a content request from the mobile device for accessing the proxied URL, the content request containing an access token;
(e) evaluating the access token contained in the content request to determine if it corresponds to the unique access token previously communicated to the mobile device; and
(f) responsive to making a positive determination that the access token contained in the content request corresponds to the unique access token previously communicated to the mobile device, proxying the content request to the web resource containing the secure content.

2. The method in accordance with claim 1, further comprising delaying sending the second message to the mobile device after communicating the unique access token thereto.

3. The method in accordance with claim 1, wherein the unique access token is communicated to the mobile device in a cookie, which is subsequently stored in a HTTP cookie store by a browser resident on the mobile device.

4. The method in accordance with claim 3, wherein the cookie is included in the content request for accessing the proxied URL, and wherein the third-party proxy service extracts the access token from the cookie for determining its validity.

5. The method in accordance with claim 1, wherein the third-party proxy service processes the content delivery request message to determine a unique identifier for the mobile device and wherein the access token is registered against the unique identifier.

6. The method in accordance with claim 5, wherein step (f) further comprises determining whether a unique identifier associated with the content request message corresponds to the unique identifier associated with the content delivery message and proxying the content request in response to making a positive determination.

7. The method in accordance with claim 1, wherein the content request is proxied to the web resource containing the secure content using a predefined encryption technique.

8. The method in accordance with claim 1, wherein the content delivery request message is intercepted by an API operated by the third-party proxy service.

9. The method in accordance with claim 1, wherein the messages sent and received by the third-party proxy service to or from the mobile device are SMS messages.

10. The method in accordance with claim 1, wherein the second message contains a hyperlink to the proxied URL, which is selectable by the content recipient.

11. A system for sending secure content to a content recipient via a mobile device, the system comprising:
a third-party proxy service configured to receive a content delivery request message containing a first URL to a web resource containing the secure content, responsive to receiving the message, the third-party proxy service further configured to:
(a) send a first message to the mobile device containing a second URL to a web resource operated by the third-party proxy service;
(b) communicate a unique access token to the mobile device responsive to the mobile device accessing the second URL;
(c) send a second message to the mobile device containing a proxied URL selectable for routing the mobile device to the secure content web resource via the third-party proxy service;
(d) receive a content request from the mobile device for accessing the proxied URL, the request containing an access token;
(e) evaluate the access token contained in the content request to determine if it corresponds to the unique access token previously communicated to the mobile device; and
(f) responsive to making a positive determination that the access token contained in the content request corresponds to the unique access token previously communicated to the mobile device, proxy the content request to the web resource containing the secure content.

12. A non-transitory computer readable storage medium comprising at least one instruction which, when implemented by a computer processor, is operable to carry out the method in accordance with claim 1.

13. A method for sending secure content to a content recipient via a mobile device, the method comprising:
receiving a content delivery request message containing a first URL to a web resource containing the secure content, the content delivery request message being received by a third-party proxy service;
responsive to receiving the content delivery request message, the third-party proxy service:
evaluating a device identifier to confirm that a unique access token was previously assigned to the mobile device;
sending a message to the mobile device containing a proxied URL selectable for routing the mobile device to the web resource containing the secure content via the third-party proxy service;
receiving a content request from the mobile device for accessing the proxied URL, the content request containing the access token;
evaluating the access token contained in the content request to determine if it corresponds to the unique access token previously communicated to the mobile device; and
responsive to making a positive determination that the access token contained in the content request corresponds to the unique access token previously communicated to the mobile device, proxying the content request to the web resource containing the secure content.
